(19) United States
(12) Patent Application Publication
(10) Pub. No.: US 2015/0046591 A1
(43) Pub. Date: Feb. 12, 2015

(54) DYNAMIC EDGE SERVER ALLOCATION

(71) Applicants: Zhongwen Zhu, Saint-Laurent (CA); Francis Page, Laval (CA)

(72) Inventors: Zhongwen Zhu, Saint-Laurent (CA); Francis Page, Laval (CA)

(21) Appl. No.: 13/963,266

(22) Filed: Aug. 9, 2013

(51) Int. Cl. H04L 12/911

(52) U.S. Cl. CPC H04L 47/70
USPC 709/226

(57) ABSTRACT

A system and method for managing edge servers and the location of edge servers in a content delivery network is provided. Incoming content requests to a plurality of existing edge servers are analyzed with respect to their originating locations. It is determined that a new edge server should be added to the network at a location where none of the plurality of existing edge servers reside. A data center is selected in accordance with the desired location, and a new edge server is instantiated. Traffic handled by two or more of the existing edge servers can be consolidated and routed to the new edge server. Edge servers are dynamically added to and removed from the network.

### TECHNICAL FIELD

This invention relates generally to content delivery networks. In particular, systems and methods for allocating and de-allocating edge servers in the network.

### BACKGROUND

With the rapid evolution of Cloud Computing it has become increasingly common to run computer programs on virtual machines operating on servers. A virtual machine (VM) is a software implementation of a machine (i.e. a computer) that executes programs like a physical machine. The physical hardware on which virtual machines run is referred to as the host or host computer(s) and can reside in data center facilities.

Data centers are facilities used to house computer systems and associated components, typically including routers and switches to transport traffic between the computer systems and external networks. Data centers generally include redundant power supplies and redundant data communications connections to provide a reliable infrastructure for operations and to minimize any chance of disruption.

Virtualization has several advantages over conventional computing environments. The operating system and applications running on a virtual machine often require only a fraction of the full resources available on the underlying physical hardware on which the virtual machine is running. A host system can employ multiple physical computers, each of which runs multiple virtual machines. Virtual machines can be created and shut down as required, thus only using the resources of the physical computer(s) as needed.

A content delivery network or content distribution network (CDN) is a large distributed system of servers deployed in multiple data centers. The goal of a CDN is to serve content to end-users with resources that are physically near to the network equipment that are receiving the content requests.

FIG. 1 illustrates a conventional CDN architecture. The content to be distributed is first ingested by the Parent Server 10 and can be stored in data storage 12. The management system 14 determines that content should be provided to edge servers 16 and 18 based upon the location(s) of the content requestors. The content can be cached in the edge servers 16 and 18 according to the characteristics of the particular media content, e.g. if it is managed or unmanaged content. Content can be cached at an edge server 16 or 18 based on the real-time demand for the content. Alternatively, content can be pre-cached at an edge server 16 or 18 based on a predicted demand for that particular content. The objective of this architecture is to physically locate the edge servers 16 and 18 as close as possible to the end user to avoid any extra latency from the network. Edge servers 16 and 18 can provide user equipment (UE) 20a-20g with content based on their location.

In the conventional CDN architecture, edge servers are physically deployed in different locations around the world and are owned and operated by the CDN provider. Using virtualization techniques, a CDN operator can scale-up or scale-down virtual resources at their edge servers as needed. However, due to the fixed geographic location of the edge servers and the proprietary nature of the CDN network, these servers are not flexible enough to respond to a sudden change of traffic generated by unpredicted consumers at certain locations.

Therefore, it would be desirable to provide a system and method that obviate or mitigate the above described problems.

### SUMMARY

It is an object of the present invention to obviate or mitigate at least one disadvantage of the prior art.

In a first aspect of the present invention, there is provided a method for managing a content delivery network including a plurality of existing edge servers. It is determined that a new edge server should be added to the content delivery network at a location where none of the plurality of existing edge servers reside. A data center is selected in accordance with the location, and the new edge server is instantiated at the selected data center.

In an embodiment of the first aspect, a content request is routed towards the instantiated new edge server. The step of routing can include receiving the content request from a user equipment and redirecting the content request to the instantiated new edge server.

In another embodiment, the step of determining that the new edge server should be added to the content delivery network is performed in response to analyzing content requests received by the plurality of existing edge servers. The analysis can include analyzing originating locations associated with the received content requests. The analysis can include mapping an IP address to a geographic position.

In another embodiment, one of the plurality of existing edge servers can be removed from the content delivery network in response to the step of instantiating the new edge server.

In another embodiment, the data center is selected from a list of candidate data centers in accordance with a proximity of the data center to the location.

In another embodiment, the method includes consolidating traffic handled by two of the plurality of existing edge servers, and routing the consolidated traffic to the instantiated new edge server. The two of the plurality of existing edge servers can be removed from the content delivery network.

In a second aspect of the present invention, there is provided a content delivery network manager, managing a plurality of existing edge servers, comprising a communication interface, a processor, and a memory. The memory contains instructions executable by the processor. The content delivery network manager is operative to determine, by the processor, that a new edge server should be added to the content delivery network at a location where none of the plurality of existing edge servers reside. A data center is selected in accordance with the location. Instructions are sent, through the communication interface, to instantiate the new edge server at the selected data center.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a prior art network architecture;

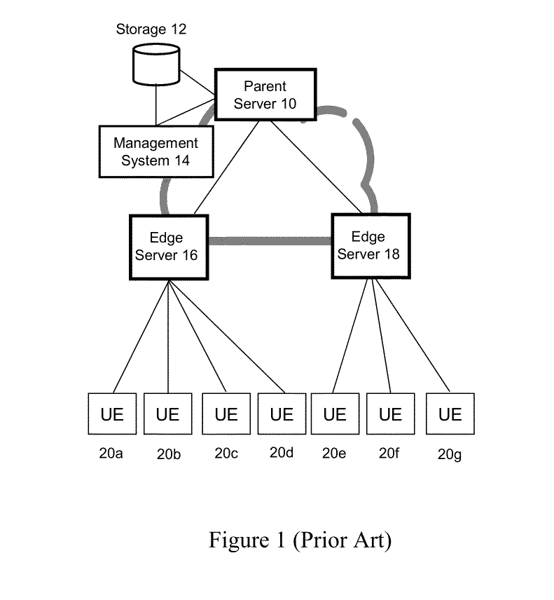

FIG. 2 is a block diagram illustrating a network overview;

FIGS. 3A and 3B illustrate adding an edge server to a CDN network;

FIG. 4 is a call flow diagram according to an embodiment of the present invention;

FIGS. 5A and 5B illustrate removing an edge server from a CDN network;

FIG. 6 is a call flow diagram according to an embodiment of the present invention;

FIGS. 7A and 7B illustrate consolidating edge servers in a CDN network;

FIG. 8 is a flow chart illustrating an embodiment of the present invention; and

FIG. 9 is a block diagram illustrating an example network node.

### DETAILED DESCRIPTION

The present invention is directed to a system and method for dynamically allocating and de-allocating edge server resources at locations in a content delivery network.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

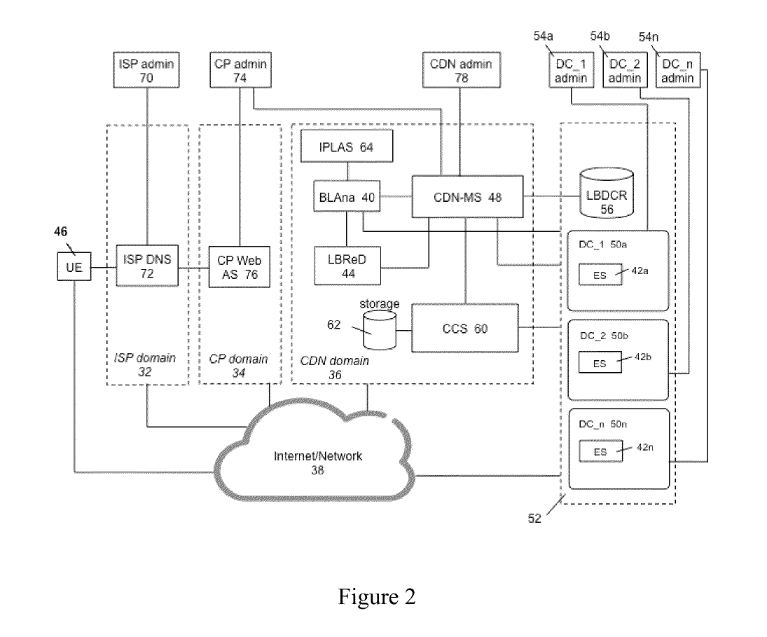

FIG. 2 is a block diagram illustrating a network overview according to embodiments of the present invention. The procedure of delivering media content from a content provider to consumers can be described as involving three domains—the Internet Service Provider (ISP) domain 32, the Content Provider (CP) domain 34, and the CDN domain 36. The three domains can be connected by a network 38 such as the Internet or a telecommunication network.

A Bandwidth and Location based Analytics (BLAna) component 40 is configured to collect the bandwidth usage and location of the consumer from the edge servers 42a-42n. The location can be either the IP address of the service request or the real location where the service request originates from. A CDN Location-based Redirector (LBReD) 44 is provided to direct a service request to the appropriate edge server 42a-42n based upon the location of the service requestor, consumer or UE 46.

The BLAna component 40 validates the collected information with a set of criteria specified by either the Content Provider or the CDN operator. This comparison can trigger a determination to add or remove one or more edge servers to the CDN network. In the case where a new edge server is to be added, a request that contains the required location and bandwidth is forwarded to the CDN management system (CDN-MS) 48. CDN-MS 48 will search for a data center that meets the requested bandwidth and location. A data center meeting this profile may be outside of the current CDN network shown as data centers 50a-50n hosting edge servers 42a-42n.

CDN-MS 48 will send the image file to the selected data center so that the data center can instantiate and launch a new virtual edge server. After receiving a successful acknowledgement from the data center, the CDN-MS 48 sets up access to the newly added edge server in the LBReD 44. Customers located in proximity to the newly added edge server can then stream the requested media content from a closer source.

As shown in FIG. 2, a data center domain 52 that provides edge servers 42a-42n for the CDN network is introduced. Each of the data centers 50a-50n can have its own dedicated management and administrative system 54a-54n. This opens up a new potential business relationship between a CDN operator and a cloud computing data center supplier. In order to support this type of business model, a new interface between the CDN domain 36 and the data center domain 52 must be considered. A Location-based Data Center Repository (LBDCR) 56 is provided for CDN related central services such as service discovery, service engagement, service registration, service subscription and publication, etc.

The Content Core Server (CCS) 60, and attached storage 62, is provided to store the ingested media content for the CDN network. It serves as the central, originating server for the edge servers 42a-42n. An edge server 42a-42n will fetch content from the CCS 62 if the content is not present in its cache when a consumer requests it. The IP-Location Application Server (IPLAS) component 64 is provided to perform the mapping from an IP address to a physical, geographic location and will be utilized by the BLAna component 40.

In the CP domain 34, CP Web Application Server (AS) 76 is provided to host the Content Provider web site/server. Media content is typically published on the CP web site.

In the ISP domain 32, ISP Domain Name Server (DNS) 72 provides the IP address of the next routing server based upon the destination address in the request from UE. The ISP provides the Internet connection for the UE 46. An alternative is a Wi-Fi connection, which can be operated by different ISPs (mobile or fixed network operators).

The Content Provider signs a contract with a CDN service provider, who can deal with different Data Centers for its edge delivery nodes. The CDN provider also provides content management functions to the Content Provider for efficient content delivery. CDN admin 78 is an interface towards CDN administrator. It allows the administrator to set up and manage the account and media contents for the Content Provider. Similarly, ISP admin 70 and CP admin 74 are also provided.

Although the various functional elements of the CDN domain 36 are shown as separate logical entities in FIG. 2, it will appreciated by those skilled in the art that they can implemented in a single physical node or in multiple physical nodes. In some embodiments, the CDN management system 48 can implement all of the management, administrative, and analytical functions for the CDN network.

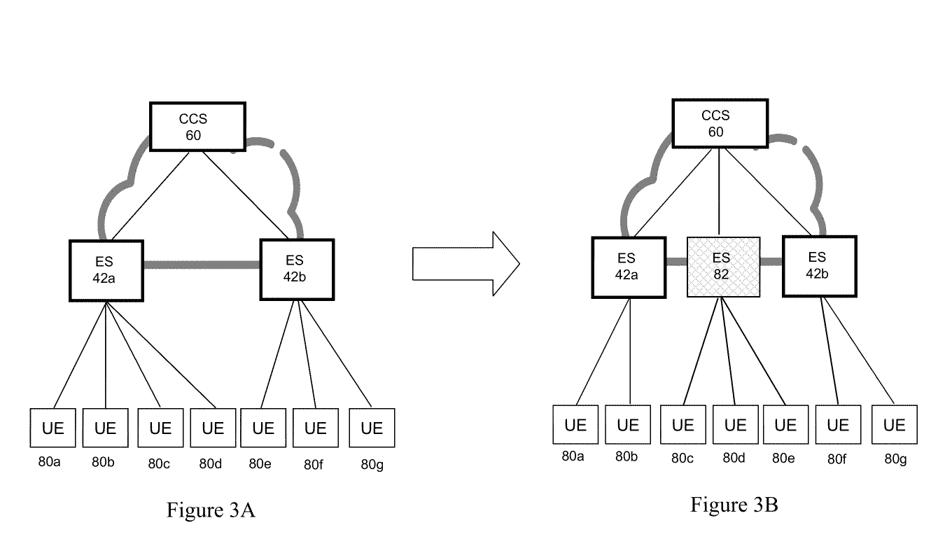

FIGS. 3A and 3B illustrate an embodiment where an edge server is created and added to the CDN network. The CCS 60 is shown as delivering content to the edge servers 42a and 42b. It can be assumed that an end user may have multiple devices (UEs) for receiving content. The end user is the consumer of the media contents which are provided by the content provider. The CDN network is used to deliver the content to a UE associated with an end user. Initially, in FIG. 3a, edge server 42a serves UEs 80a, 80b, 80c, 80d. Edge server 42b serves UEs 80e, 80f, 80g. When the number of requests from UEs 80a-80g increases, the edge servers 42a, 42b (and/or the LBReD, not shown in FIGS. 3a and 3b) will report the change in traffic as well as the location where the traffic is originating from to the BLAna. Based upon this collected information, the BLAna decides if a new edge server is required for a new location to better serve the increased demand. In this scenario, a new edge server 82 is added, hosted at a datacenter at a new location, to meet the changing traffic demands. In FIG. 3b, edge server 42a now serves UEs 80a, 80b. Newly launched edge server 82 serves UEs 80c, 80d, 80e. Edge server 42b serves UEs 80f, 80g.

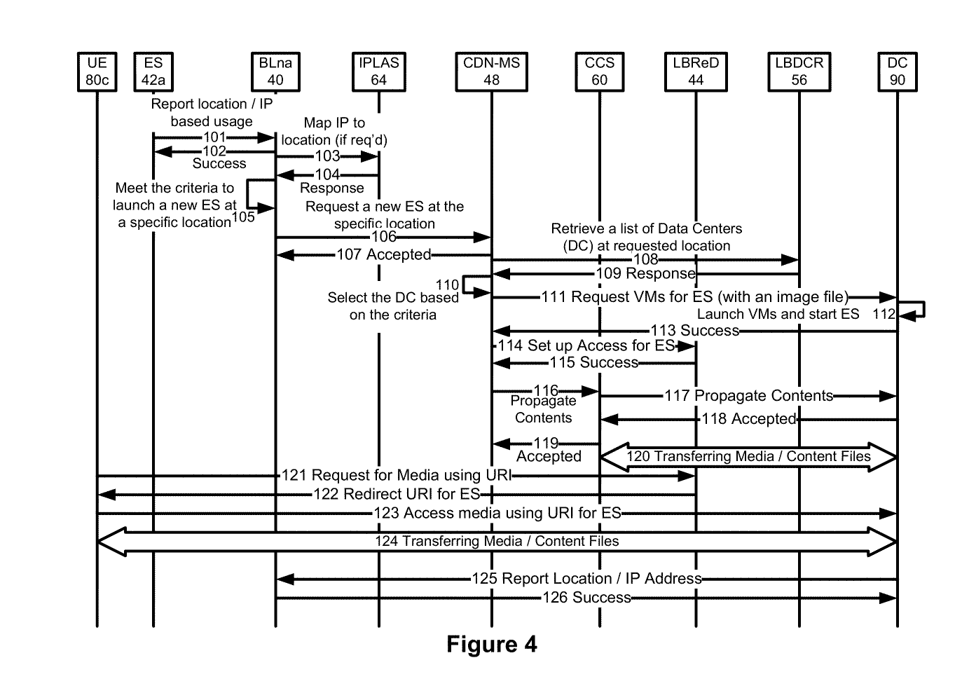

FIG. 4 is a call flow diagram illustrating the creation of a new edge server in a selected data center. Edge server 42a reports the IP address and/or location associated with the traffic it handles to the BLAna 40 (step 101). Other active edge servers in the network can also report their usage to the BLAna 40. BLAna 40 acknowledges the reporting (step 102). If required, the BLAna 40 requests that the IPLAS 64 maps the IP address to a geographic location (step 103), and IPLAS 64 returns the requested information (step 104). The BLAna 40 determines if the criteria has been met to launch a new edge server at a specific location (step 105). If the criteria are satisfied, a request is sent to the CDN-MS 48 for the new edge server at the desired location (step 106). The CDN-MS 48 can acknowledge the request (step 107).

The CDN-MS 48 then retrieves a list of data centers at the requested location (step 108). The LBDCR 56 responds with the credentials of any appropriate data centers (step 109). The CDN-MS 48 selects a data center for hosting the new edge server (step 110). This selection can made based on a number of factors including location, data center capabilities, available bandwidth, cost, etc.

Following the selection of the data center, the CDN-MS 48 sends a request to Data Center 90 to instantiate the virtual machines required for the edge server (step 111). The request can include the image file(s) required for the virtual machines. Data Center 90 receives the request, instantiates the required virtual machines and launches a new edge server (step 112). Data Center 90 acknowledges the edge server launch to the CDN-MS 48 (step 113). CDN-MS 48 coordinates the set-up of the new edge server with respect to access to the CDN network with the LBReD 44 (step 114). LBReD 44 acknowledges when the network access is successfully set-up (step 115). The CDN-MS 48 then instructs the CCS 60 to propagate content to the newly launched edge server (step 116). The CCS 60 relays this instruction to the Data Center 90 (step 117), which acknowledges the CCS 60 (step 118) and the CDN-MS (step 119).

Content is transferred from the CCS 60 to the new edge server hosted in Data Center 90 (step 120). This transfer of media files can be via HTTP or any other appropriate protocol or mechanism. There can be a PUSH mechanism from the CCS 60 to the edge server or, alternatively, a PUSH-PULL mechanism from the CCS 60 to the edge server (CCS 60 informs the ES of the file names locations, then ES starts to pull the content). The particular media files transferred to the new edge server can be selected based on the same traffic/usage reports that were generated in step 101. Alternatively, the content to be transferred can be selected in accordance with a prediction or forecast of the expected requests that will originate from the end-users to be served by the new edge server.

UE 80c makes a request for content using its stored URI for the LBReD 44 (step 121). Although FIG. 4 does not explicitly show the steps required for UE 80c to initially obtain the URI for LBReD 44, they will be readily understood by those skilled in the art. In one embodiment, the UE 80c can access the CP web AS via the Internet or ISP network. UE 80c selects the media content that the consumer is interested in, and the CP web AS returns the IP address (e.g. the URI) of the LBReD 44 to the UE 80c.

Returning to FIG. 4, the LBReD 44 receives the request and sends a URI redirection message to the UE 80c, redirecting it to the new edge server in Data Center 90 (step 122) based upon the location information of UE embedded in the HTTP request. The UE 80c uses the received URI to make its content request to the new edge server (step 123). A content session is established, and the media files are transferred to the UE 80c (step 124). The new edge server can report the IP address and/or location associated with the traffic it handles to the BLAna 40 (step 125), and the process for determining the optimal location(s) for edge servers can continue. The report is acknowledged by the BLAna 40 (step 126).

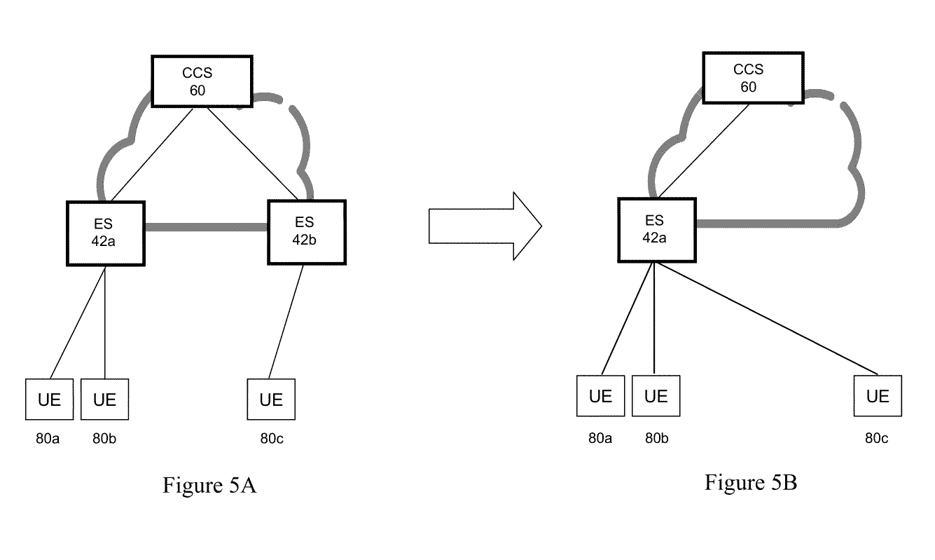

FIGS. 5A and 5B illustrate an embodiment where an edge server is removed from the CDN network. Initially, in FIG. 5A, edge server 42a serves UEs 80a, 80b while edge server 42b serves UE 80c. When the number of service requests reduces at a certain area or location, BLAna is notified from the information collected from the edge server(s) assigned to that area. Alternatively, the LBReD (not shown in FIGS. 5A and 5B) can accumulate and provide this information to the BLAna. In this scenario, it is be determined that edge server 42b can be removed for cost savings due to the low amount of content it is serving. The remaining traffic on edge server 42b shall be handed over to edge server 42a prior to terminating edge server 42b. In FIG. 5B, edge server 42a now serves UEs 80a, 80b, 80c and edge server 42b has been removed from the CDN network.

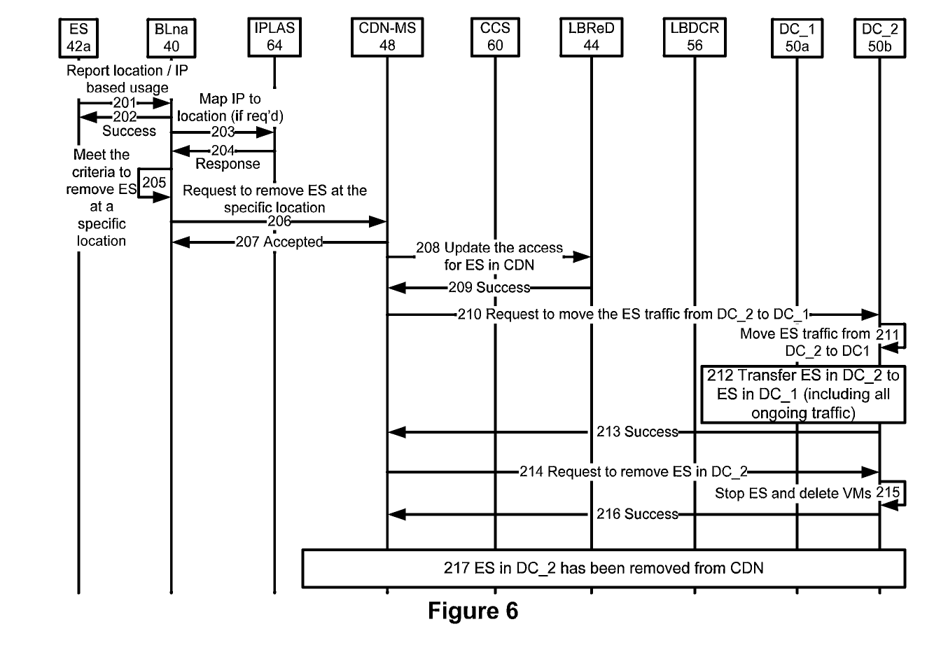

FIG. 6 is a call flow diagram illustrating the removal of an edge server at a selected data center. Edge server 42a reports the IP address and/or location associated with the traffic it handles to the BLAna 40 (step 201). Other active edge servers in the network can also report their usage to the BLAna 40. BLAna 40 acknowledges the reporting (step 202). If required, the BLAna 40 requests that the IPLAS 64 maps the reported IP address to a geographic location (step 203), and IPLAS 64 returns the requested information (step 204). The BLAna 40 determines if the criteria has been met to remove an edge server at a specific location from the CDN network (step 205). If the criteria are satisfied, a request is sent to the CDN-MS 48 for the edge server removal at the specified location (step 206). The CDN-MS 48 can acknowledge the request (step 207).

The CDN-MS 48 sends an access update for the edge server to be removed to the LBReD 44 (step 208). The LBReD 44 updates its routing table and sends an acknowledgement to the CDN-MS 48 (step 209). The CDN-MS 48 then sends a request to Data Center DC_{—}2 50b to migrate traffic associated with the edge server to be removed to Data Center DC_{—}1 50a (step 210). Data Center DC_{—}2 50b will then transfer the edge server traffic to Data Center DC_{—}1 50a (step 211) and transfer any required content or data from the edge server in DC_{—}2 50b to DC_{—}1 50a (step 212). The successful movement of all ongoing traffic from DC_{—}2 to DC_{—}1 is then acknowledged to the CDN-MS 48 (step 213).

CDN-MS 48 can then send a request to DC_{—}2 50b to remove the edge server hosted at DC_{—}2 50b (step 214). DC_{—}2 50b terminates its hosted edge server and deletes the associated virtual machines (step 215). The removal of the edge server in DC_{—}2 50b is acknowledged to the CDN-MS 48 (step 216). The edge server in DC_{—}2 50b has now been removed from the CDN network and no future content requests will be routed to DC_{—}2 50b (step 217).

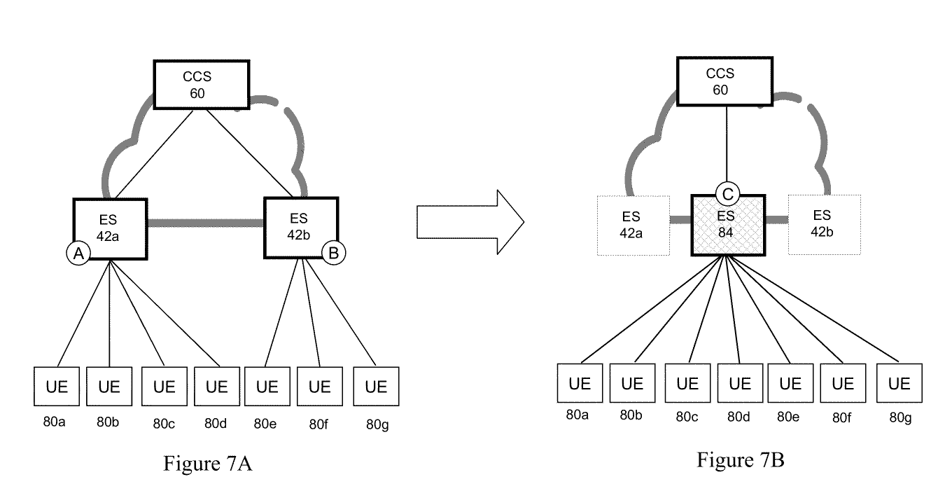

FIGS. 7A and 7B illustrate an embodiment where edge servers are consolidated at a new edge server at a selected data center in a CDN network. This use case is an example of an optimization scenario for the CDN network. It will be appreciated that this scenario can be realized as a combination of the scenarios described in FIGS. 3A, 3B and FIGS. 5A, 5B. Initially, in FIG. 7A, edge server 42a at location A serves UEs 80a, 80b, 80c, 80d. Edge server 42b at location B serves UEs 80e, 80f, 80g. Based on the information collected from edge servers 42a and 42b (or the LBReD), BLAna concludes that the optimized edge deployment is to have a new single edge server 84 located at new location C as opposed to having edge servers at both locations A and B. In FIG. 7B, new edge server 84 now serves all UEs 80a-80g, while previous edge servers 42a and 42b have been removed from the CDN network. Aspects of the call flow diagrams of FIGS. 4 and 6 can be combined to simultaneously add a new edge server(s) to the CDN network and to remove existing edge server(s) from the network.

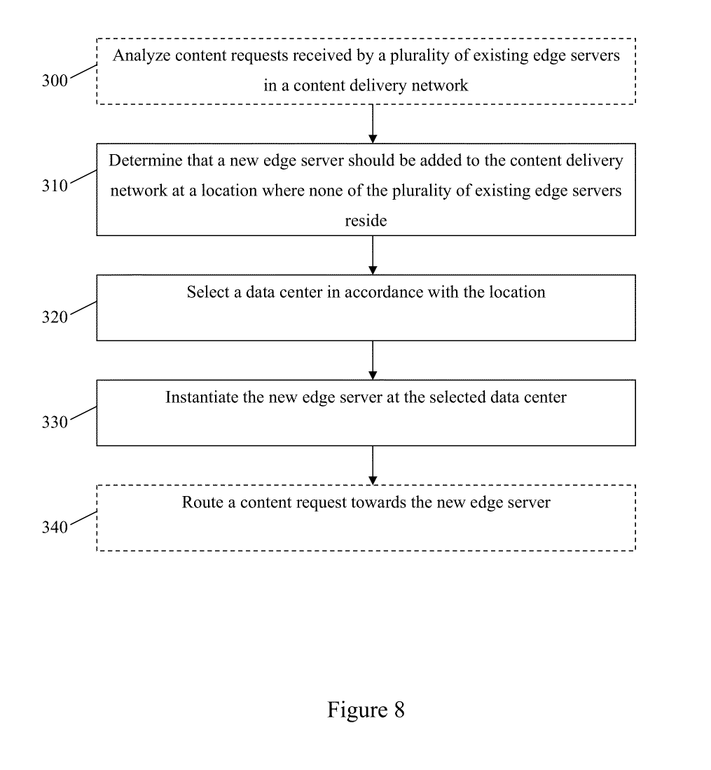

FIG. 8 is a flow chart illustrating an embodiment of the present invention. FIG. 8 shows a method for managing a content delivery network including a plurality of existing edge servers. The method can be performed by a CDN manager or management system. Each of the plurality of existing edge servers has an associated geographic location where they are known to reside. The existing edge servers can be hosted by data centers in varying locations.

In block 300, content requests received by the plurality of existing edge servers are optionally analyzed. The content requests can be analyzed with respect to the originating IP address and/or location of the client device, the location of the edge servers, the traffic load of the edge servers, as well as their utilization costs and other factors. An IP address associated with a content request (or a content requestor) can be mapped to a geographic position. The outcome of this analysis can provide an optimized network to deliver the media content with a lower cost and excellent user experience. The content requests analyzed in block 300 can be a stored list of all requests received over a period of time. Alternatively, the content requests can include the traffic that is currently being handled by the existing edge servers.

In block 310, it is determined that a new edge server should be added to the content delivery network at a location where none of the plurality of existing edge servers reside. This determination can be made in response to the analysis of block 300.

In block 320, a data center is selected in accordance with the location determined for the new edge server. The data center can be selected from a list of candidate data centers based on its proximity to the desired location for the new edge server, availability of resources, cost, or other factors.

In block 330, a new edge server is instantiated at the selected data center. Instructions to launch the new edge server can be transmitted from the content delivery network manager to the selected data center. The instructions can include image files to be used by the data center to instantiate virtual machines required for the edge server.

Following the instantiation of the new edge server, a content request can be routed to the new edge server in block 340. The step of routing can include receiving a content request from a user equipment, determining that it should be handled by the new edge server, and redirecting the request towards the new edge server.

Optionally, the method of FIG. 8 can also include the step of removing one of the plurality of existing edge servers from the content delivery network. The determination to remove an existing edge server can be made in response to the step of analyzing the content requests received by the plurality of edge servers. Alternatively, the determination to remove an existing edge server can be made in response to the step of instantiating the new edge server at the selected data center. The traffic handled by two or more of the plurality of existing edge servers can be consolidated and routed to the instantiated new edge server. The two (or more) existing edge servers can then be removed from the content delivery network.

In order to efficiently utilize the CDN network and its edge server resources, embodiments of the present invention collect usage information from all active edge servers in the network and, at the same time, can examine services offered by different services providers such as CDN service providers and Cloud service providers that are outside of the operator's network. Based on the collected information and the availability of external resources, the CDN network manager can decide to add, remove or consolidate edge servers as has been described herein.

Some embodiments can involve collaboration between multiple CDN service providers. A CDN Federation to provide interconnectivity between telecom operators, CDN operators and content service providers has been proposed. In order to expand CDN coverage, a CDN operator can sign a service-level agreement (SLA) with other CDN operators to enable resource sharing when required. For example, a first CDN operator could consolidate two of its own edge servers into one edge server located in a second CDN operator's network based on network usage analysis.

General Cloud (or Data Center) service providers can similarly be employed to expand the CDN network coverage. A CDN operator can optimize its delivery network by periodically querying for available cloud resources/services. A cloud service provider can publish its offerings in a central repository. A CDN operator can discover the service(s) by consulting the repository. For example, after discovering a particular cloud service, a CDN operator can move its current active edge servers to be hosted by the Cloud service provider(s). An edge server can be launched by instantiating virtual machines at the Cloud service provider, and then the active edge servers in the CDN network can be migrated to those virtual machines.

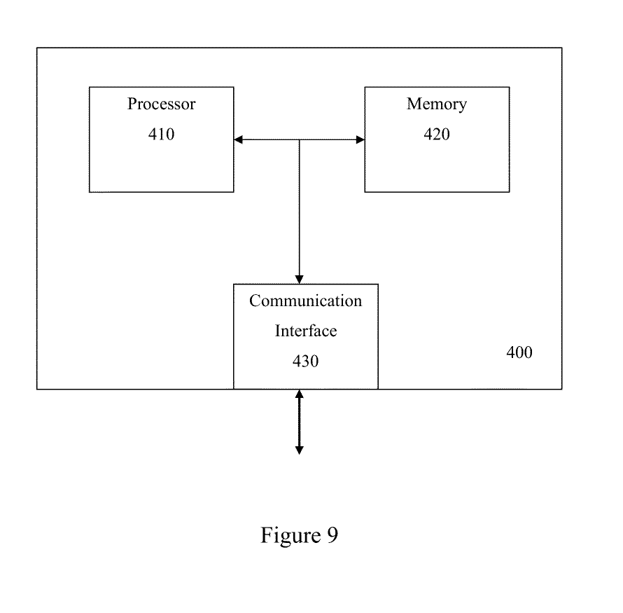

FIG. 9 is a block diagram illustrating an example network node 400 of the present invention which can perform the functionality of a content delivery network manager as described in the various embodiments of the present invention. Node 400 includes a processor 410, a memory or data repository 420 and a communication interface 430. The data repository 420 can be internal or external to node 400, but is accessible by the processor 410. The memory 420 contains instructions executable by the processor 410 whereby the network node 400 is operative to perform the embodiments of the present invention as described herein. Although the detailed requirements for the components, subassemblies, etc., may differ depending on which of the CDN management functions are performed by node 400, the performance requirements for each are well known in the art.

Content delivery network manager 400 is configured to manage a plurality of existing edge servers in the network. The processor 410 determines that a new edge server should be added to the content delivery network at a location where none of the plurality of existing edge servers reside. The processor 410 can make this determination by analyzing content requests that have been received by, redirected to, or routed towards the existing edge servers. These content requests can be analyzed with respect to their originating IP or geographic locations. The processor 410 selects a data center in accordance with the determined location. The data center can be selected from a list of candidate data centers based on its proximity to the desired location. Instructions are transmitted, through the communication interface 430, to instantiate a new edge server at the selected data center.

Content delivery network manager 400 can be further configured to consolidate traffic handled by two of the existing edge servers, and route that consolidated traffic to the instantiated new edge server. The two existing edge servers can be subsequently removed from the network by sending instructions to the data centers where they are hosted.

Embodiments of the present invention provide flexibility and scalability which facilitate a CDN operator to deliver media content based on the real-time demands and locations of the end users. As traffic increases, a number of edge servers can be added to the CDN network in specific regions or locations as opposed to simply adding additional resources at static edge server sites. When the traffic decreases, edge servers can be removed from the CDN network to reduce operational and maintenance costs. Furthermore, embodiments of the present invention can improve the end user experience due to dynamically allocating edge server resources closer to the end user location to reduce latency.

Embodiments of the invention may be represented as a software product stored in a machine-readable medium (also referred to as a computer-readable medium, a processor-readable medium, or a computer usable medium having a computer-readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for managing a content delivery network including a plurality of existing edge servers, comprising:
determining that a new edge server should be added to the content delivery network at a location where none of the plurality of existing edge servers reside;
selecting a data center in accordance with the location; and
instantiating the new edge server at the selected data center.

2. The method of claim 1, further including the step of routing a content request towards the instantiated new edge server.

3. The method of claim 2, wherein the step of routing includes receiving the content request from a user equipment and redirecting the content request to the instantiated new edge server.

4. The method of claim 1, wherein the step of determining that the new edge server should be added is responsive to analyzing content requests received by the plurality of existing edge servers.

5. The method of claim 4, further including analyzing originating locations associated with the received content requests.

6. The method of claim 4, wherein the step of analyzing includes mapping an IP address to a geographic position.

7. The method of claim 1, further including the step of removing one of the plurality of existing edge servers from the content delivery network in response to instantiating the new edge server.

8. The method of claim 1, wherein the data center is selected from a list of candidate data centers in accordance with a proximity of the data center to the location.

9. The method of claim 1, further including consolidating traffic handled by two of the plurality of existing edge servers, and routing the consolidated traffic to the instantiated new edge server.

10. The method of claim 9, further including removing the two of the plurality of existing edge servers from the content delivery network.

11. A content delivery network manager, managing a plurality of existing edge servers, comprising a communication interface, a processor, and a memory, the memory containing instructions executable by the processor whereby the content delivery manager is operative to:
determine, by the processor, that a new edge server should be added to the content delivery network at a location where none of the plurality of existing edge servers reside;
select a data center in accordance with the location; and
send instructions, through the communication interface, to instantiate the new edge server at the selected data center.

12. The content delivery network manager of claim 11, further operative to route a content request, received by the communication interface, towards the instantiated new edge server.

13. The content delivery network manager of claim 11, wherein the processor determines that the new edge server should be added in response to analyzing content requests received by the plurality of existing edge servers.

14. The content delivery network manager of claim 13, further including analyzing originating locations associated with the received content requests.

15. The content delivery network manager of claim 13, further including mapping an IP address to a geographic position.

16. The content delivery network manager of claim 11, further operative to remove one of the plurality of existing edge servers in response to instantiating the new edge server.

17. The content delivery network manager of claim 11, wherein the processor selects the data center from a list of candidate data centers in accordance with a proximity of the data center to the location.

18. The content delivery network manager of claim 11, further operative to consolidate traffic handled by two of the plurality of existing edge servers, and route the consolidated traffic to the instantiated new edge server.

19. The content delivery network manager of claim 18, further operative to remove the two of the plurality of existing edge servers from the content delivery network.
